(19) United States
(12) Patent Application Publication
(10) Pub. No.: US 2014/0074811 A1
(43) Pub. Date: Mar. 13, 2014

(54) QUERY RANKING MODELS

(71) Applicants: Øivind Wang, Oslo (NO); Nicolai Bodd, Stabekk (NO); Rune Djurhuus, Oslo (NO)

(72) Inventors: Øivind Wang, Oslo (NO); Nicolai Bodd, Stabekk (NO); Rune Djurhuus, Oslo (NO)

(73) Assignee: MICROSOFT CORPORATION, Redmond, WA (US)

(21) Appl. No.: 13/606,032

(22) Filed: Sep. 7, 2012

(51) Int. Cl. G06F 17/30

(52) U.S. Cl. 707/706; 707/E17.108

(57) ABSTRACT

Concepts and technologies are described herein for query ranking models. In accordance with the concepts and technologies disclosed herein, a search engine can be configured to expose a query ranking model object corresponding to a ranking function used by the search engine. A query application can be configured to obtain the query ranking model object and generate a query ranking model based upon the query ranking model object. The query ranking model can include one or more features and respective weights. The query application can generate a query and include data with the query identifying the query ranking model that is to be used to rank search results generated by the search engine. The query application also can be configured to manage query ranking models to allow creation, modification, and/or deletion of query ranking models as well as weights of features of the query ranking models.

### BACKGROUND

The proliferation of data creation and storage has resulted in an increased reliance upon various search technologies for identifying and accessing data. Generally speaking, documents or records accessible at a particular location may be indexed by a search engine and data relating to the indexed information can be stored at a database or other data structure accessible to various systems or devices. Thus, when a search query is submitted to a search engine, the search engine can execute the query against the search index, determine if records or documents matching the search query are present in the search index, order the identified records or documents in accordance with a ranking function, and return search results.

The ranking of search results is often based upon popularity of the respective search results and/or a respective determined relevancy to the submitted query. Thus, for example, if a search term appears in a document, the document can be determined to be relevant to the search query. Similarly, clicks on particular results can be logged and used to affect ranking of a document or record corresponding to the particular result in future result sets.

In some instances, however, documents or records identified as being popular and/or relevant may or may not be of interest to a particular entity. As such, ranking of the documents or records in accordance with popularity-based and/or relevance-based considerations may not be helpful to some searchers. Similarly, some documents or records are ranked higher in result sets based upon sponsorship or advertising fees. Thus, highly ranked documents or records may be of little to no interest to a searcher.

It is with respect to these and other considerations that the disclosure made herein is presented.

### SUMMARY

Concepts and technologies are described herein for query ranking models. In accordance with the concepts and technologies disclosed herein, a search engine can be configured to expose a ranking function used to rank or order search results. The ranking function can be exposed as an object such as a query ranking model object. If an entity accessed the search engine, the query ranking model object can be exposed to the entity, transmitted to the entity, and/or downloaded by the entity. In some embodiments, a computing device accessed the search engine via a web browser or other application.

The computing device can execute a query application and/or can access query application functionality provided by the search engine. The query application can be configured to receive or otherwise obtain the query ranking model object and generate a query ranking model based upon the query ranking model object. The query ranking model can include one or more features. The “features” can include various aspects or considerations of ranking search results that are to be considered by the search engine when ranking the search results. According to various embodiments, the query ranking model can include data specifying weights assigned to the various features of the query ranking model. The computing device can be configured to generate and/or store any number of query ranking models.

The computing device can generate a query and include data with the query identifying the query ranking model that is to be used to rank search results generated by the search engine. In some embodiments, the computing device can be configured to submit the query ranking model as an object that can be submitted with the query. Alternatively, the query ranking model can be identified by a flag or other data included in the query and stored elsewhere such as at the search engine, at a social networking server, with an online profile, and/or elsewhere. As such, a particular query ranking model can be specified for a particular query, if desired.

The computing device also can be configured to manage query ranking models. The computing device can be configured to allow creation, modification, and/or deletion of query ranking models. The weights of features of the query ranking models can be adjusted. Additionally, or alternatively, the features themselves can be adjusted and/or features can be added to and/or removed from the query ranking models. Changes to the query ranking models can be saved and or used for single searches, if desired. In some implementations, query ranking models can be associated with particular devices and/or users of a search engine or other search services or applications. As such, each user or device can use a personalized query ranking model, if desired.

It should be appreciated that the above-described subject matter may be implemented as a computer-controlled apparatus, a computer process, a computing system, or as an article of manufacture such as a computer-readable storage medium. These and various other features will be apparent from a reading of the following Detailed Description and a review of the associated drawings.

This Summary is provided to introduce a selection of concepts in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a system diagram illustrating an illustrative operating environment for the various embodiments disclosed herein.

FIG. 2 is a line diagram schematically showing additional aspects of a query ranking model, according to an illustrative embodiment.

FIG. 3 is a user interface diagram showing aspects of a user interface for performing a search using a query ranking model, according to an illustrative embodiment.

FIG. 4 is a user interface diagram showing aspects of a user interface for presenting and modifying query ranking models, according to an illustrative embodiment.

FIG. 5 is a flow diagram showing aspects of a method for performing a search using a query ranking model, according to an illustrative embodiment.

FIG. 6 is a flow diagram showing aspects of a method for modifying a query ranking model, according to an illustrative embodiment.

FIG. 7 is a computer architecture diagram illustrating an illustrative computer hardware and software architecture for a computing system capable of implementing aspects of the embodiments presented herein.

FIG. 8 is a diagram illustrating a distributed computing environment capable of implementing aspects of the embodiments presented herein.

FIG. 9 is a computer architecture diagram illustrating a computing device architecture capable of implementing aspects of the embodiments presented herein.

### DETAILED DESCRIPTION

The following detailed description is directed to concepts and technologies for query ranking models. According to the concepts and technologies described herein, a search engine can be configured to expose ranking function as an object such as a query ranking model object. A query application can be configured to obtain the query ranking model object and generate a query ranking model based upon the query ranking model object. The query ranking model can include one or more features, as well as weights assigned to the features. Thus, the query ranking model can include an indication of what aspects of documents or records are to be considered during ranking of search results, as well as relative weights of the aspects.

The query application can generate a query. The query can include data identifying the query ranking model that is to be used to rank search results generated by the search engine in response to the query. Search results can be received by a computing device, for example, a computing device configured to execute the query application. The search results can be ordered and/or ranked in accordance with the query ranking model submitted with the query and/or identified by the data included in the query. The query application also can be configured to manage query ranking models to allow creation, modification, and/or deletion of query ranking models. Additionally, or alternatively, weights associated with one or more features of the query ranking models can be modified by the query application, and updated or new query ranking models can be saved and used for present or future queries.

While the subject matter described herein is presented in the general context of program modules that execute in conjunction with the execution of an operating system and application programs on a computer system, those skilled in the art will recognize that other implementations may be performed in combination with other types of program modules. Generally, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like.

In the following detailed description, references are made to the accompanying drawings that form a part hereof, and in which are shown by way of illustration specific embodiments or examples. Referring now to the drawings, in which like numerals represent like elements throughout the several figures, aspects of a computing system, computer-readable storage medium, and computer-implemented methodology for query ranking models will be presented.

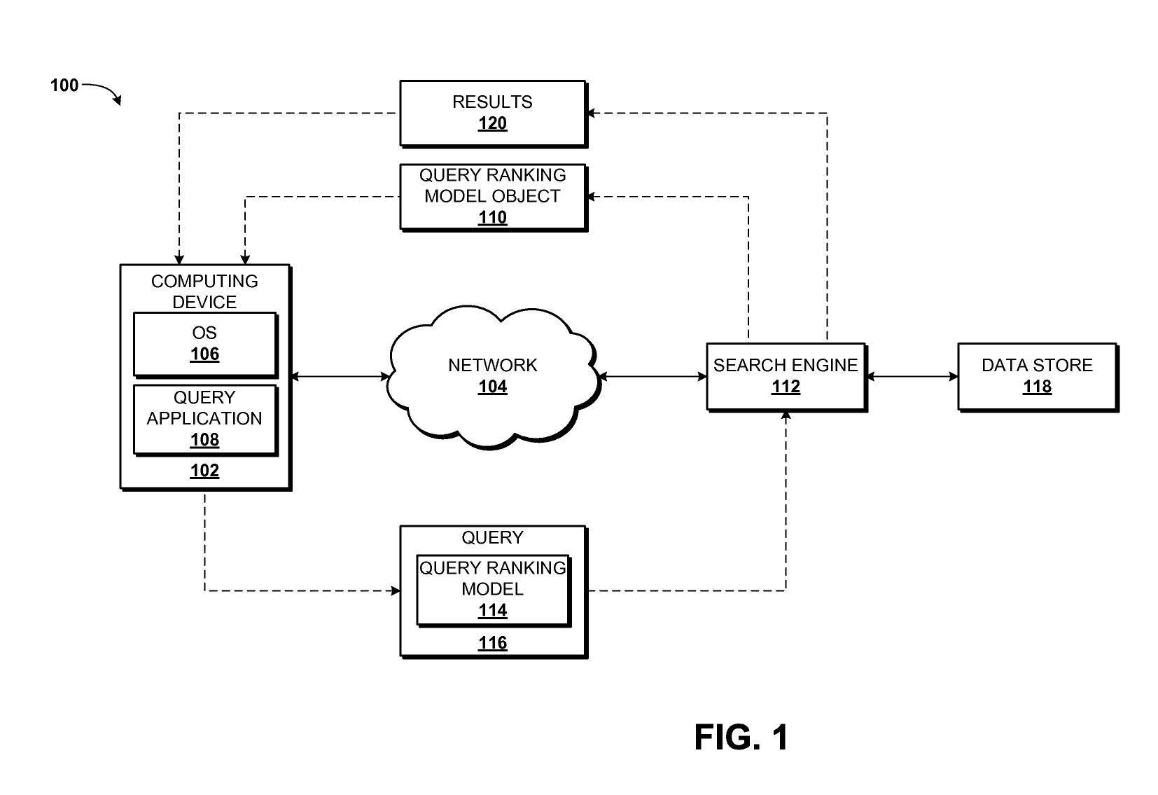

Referring now to FIG. 1, aspects of one operating environment 100 for the various embodiments presented herein will be described. The operating environment 100 shown in FIG. 1 includes a computing device 102. According to various embodiments, the functionality of the computing device 102 can be provided by a personal computer (“PC”) such as a desktop, tablet, or laptop computer system. The functionality of the computing device 102 also can be provided by other types of computing systems including, but not limited to, server computers, handheld computers, netbook computers, embedded computer systems, personal digital assistants, mobile telephones, smart phones, or other devices or systems capable of executing the various software elements described herein in detail. For purposes of describing the concepts and technologies disclosed herein, the computing device 102 is described herein as a personal computing device such as a PC, smartphone, or tablet computer. It should be understood that this embodiment is illustrative, and should not be construed as being limiting in any way.

According to some embodiments, the computing device 102 is configured to operate in communication with, or as part of, a communications network (“network”) 104. In some other embodiments, the computing device 102 does not operate in communication with the network 104. The computing device 102 can be configured to execute an operating system 106 and one or more application programs, modules, software elements, or other computer-executable or computer readable instructions such as, for example, a query application 108.

The operating system 106 is a computer program for controlling the operation of the computing device 102. The query application 108 can include an executable program configured to execute on top of the operating system 106 to provide the functionality described herein for creating, modifying, and/or using query ranking models. Although the query application 108 is illustrated as executing at the computing device 102, it should be understood that the query application 108 may be embodied as an application or module executing on a device remote from the computing device 102 such as a web server, a search engine, or the like. Thus, the functionality of the query application 108 described herein can be provided by a server computer or web server that is executed by an application program executing on the computing device 102 such as a web browser or other application program. Therefore, it should be understood that the illustrated embodiment is illustrative, and should not be construed as being limiting in any way.

The query application 108 can be configured to obtain a query ranking model object 110. The query ranking model object 110 can include an object exposed by various applications, services, and/or devices. In some contemplated embodiments, a search engine 112 can be configured to expose the query ranking model object 110 to searchers and/or other entities. Thus, the search engine 112 can be configured to allow searchers or other entities to determine how results generated by the search engine are to be ranked and/or ordered. In some embodiments, as will be described in more detail below, the query application 108 can be configured to obtain the query ranking model object 110, to modify one or more aspects of the query ranking model object 110, and/or to generate a query ranking model 114.

The query ranking model 114 generated by the query application 108 can be submitted to the search engine 112 and used to rank and/or order results identified by the search engine 112 in response to searches performed on behalf of the computing device 102. In some embodiments, the computing device 102 can be configured to submit the query ranking model 114 with a query 116. In some other embodiments, the computing device 102 can be configured to generate and/or modify query ranking models 114 at the search engine 112 and/or other devices such as social networking services (not illustrated), online profile services, or the like. Thus, the computing device 102 can be configured to submit data identifying the query ranking model 114 to be used to rank and/or order results instead of actually submitting the query ranking model 114 with the query 116. Therefore, while the illustrated embodiments are described as including the query ranking model 114 with query 116, it should be understood that this embodiment is illustrative, and should not be construed as being limiting in any way.

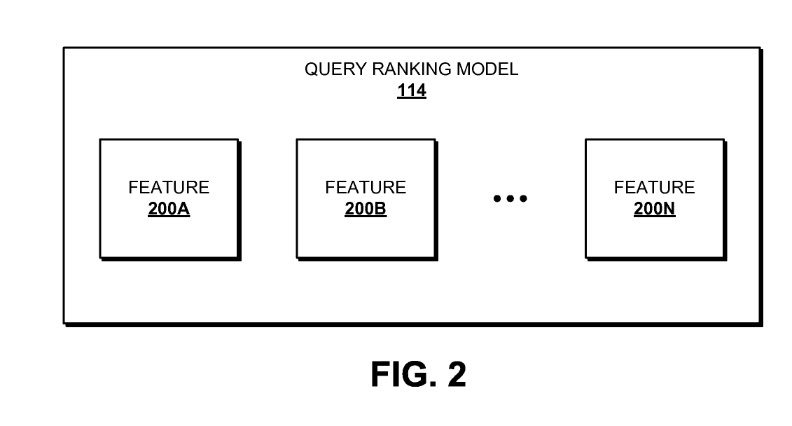

As mentioned above, the query application 108 can be configured to modify the query ranking model object 110 to generate the query ranking model 114. In particular, the query application 108 can be configured to obtain the query ranking model object 110 from the search engine 112 and/or elsewhere, and to identify one or more “features” that are included in the query ranking model object 110. As used herein, the term “features” can be used to refer to variables, constants, relationships, and/or other aspects of results generated by the search engine 112 that are to be used in ranking results identified by the search engine 112 in response to queries such as the query 116. Additional aspects of the features, as well as some examples of the features, are illustrated and described in more detail below with reference to FIG. 2.

The query ranking model object 110 can identify one or more features included and/or considered as part of the query ranking model object 110, as well as respective weights assigned to each of the included features. The weights can include percentages that define a relative importance of the particular feature in determining a rank or order of a particular hit to be included as part of a result set. In some embodiments, the features can be weighted positively and/or negatively to increase or decrease, respectively, a relative rank of a hit based upon matches between the hit and the features included in the query ranking model object 110. Features also can be weighted to zero to remove consideration of that feature when ranking and/or ordering results in a result set.

According to various embodiments, the query application 108 can be configured to obtain the query ranking model object 110 from the search engine 112 or other location, and to allow users or other entities to modify weights assigned to the various features included in the query ranking model object 110. Additionally, or alternatively, users or other entities can add or remove features included in the query ranking model object 110. The weights and feature additions or other modifications can be captured by the query application 108 and used to generate the query ranking model 114.

According to various embodiments, the query ranking model 114 can be submitted with the query 116 and disposed of immediately thereafter. In some other embodiments, the query ranking model 114 can be stored at the computing device 102, stored at the search engine 112 as associated with a particular profile or device such as the computing device 102, and/or can be stored at other devices or services. In some implementations, the query ranking model 114 can be associated with various devices and/or users of the search engine 112 and/or other search services or applications, and as such, each user or device can use a personalized query ranking model 114. In some embodiments, query ranking models 114 can be stored at social networking services or other services as associated with a particular user, profile, or device and used at various times and/or for various purposes.

The query application 108 can be configured to generate the query 116 and submit the query 116 to the search engine 112. As is generally understood, the computing device 102 can render a search page or search portal using a web browser or other application program, and the query 116 can be submitted to the search engine 112 via the search page or search portal. In response to receiving the query 116, the search engine 112 can perform a search of a search index or other dataset stored at the search engine 112 and/or in communication with the search engine 112. In the illustrated embodiment, the search engine 112 is illustrated as accessing a data store 118 that stores data against which the query 116 is run. It should be understood that the query 116 described herein can include, but is not limited to, web search strings, database queries, enterprise application search queries, or the like. As such, the data store 118 can include or can store a search index, a site index, a document repository, computing device directories, databases, other information, or the like.

The search engine 112 can generate a result set based upon the query 116. In some embodiments, the search engine 112 generates one or more search results 120. The search results 120 can be returned to a searching entity such as the computing device 102. The search results 120 can be provided to the computing device 102 as a result set, as a result page generated by the search engine 112, and/or in other formats. According to various embodiments, the search results 120 can be ordered and/or ranked in accordance with the query ranking model 114 generated by the computing device 102 as explained herein. As such, the concepts and technologies disclosed herein can be used to obtain, rank, and/or order search results 120 in accordance with a particular query ranking model 114. Additional aspects of the concepts and technologies disclosed herein for query ranking models 114 are illustrated and described below, particularly with reference to FIGS. 2-6.

The concepts and technologies disclosed herein also can be used to provide management of one or more query ranking models 114. In particular, users or other entities can access one or more query ranking models 114, select one or more query ranking models 114 for use with a particular query 116, and/or access functionality of the query application 108 for modifying or creating query ranking models 114. According to various embodiments, the query application 108 can provide a user interface for managing one or more query ranking models 114. For example, a user interface for adjusting weights of one or more features of the query ranking models 114 can be provided by the query application 108.

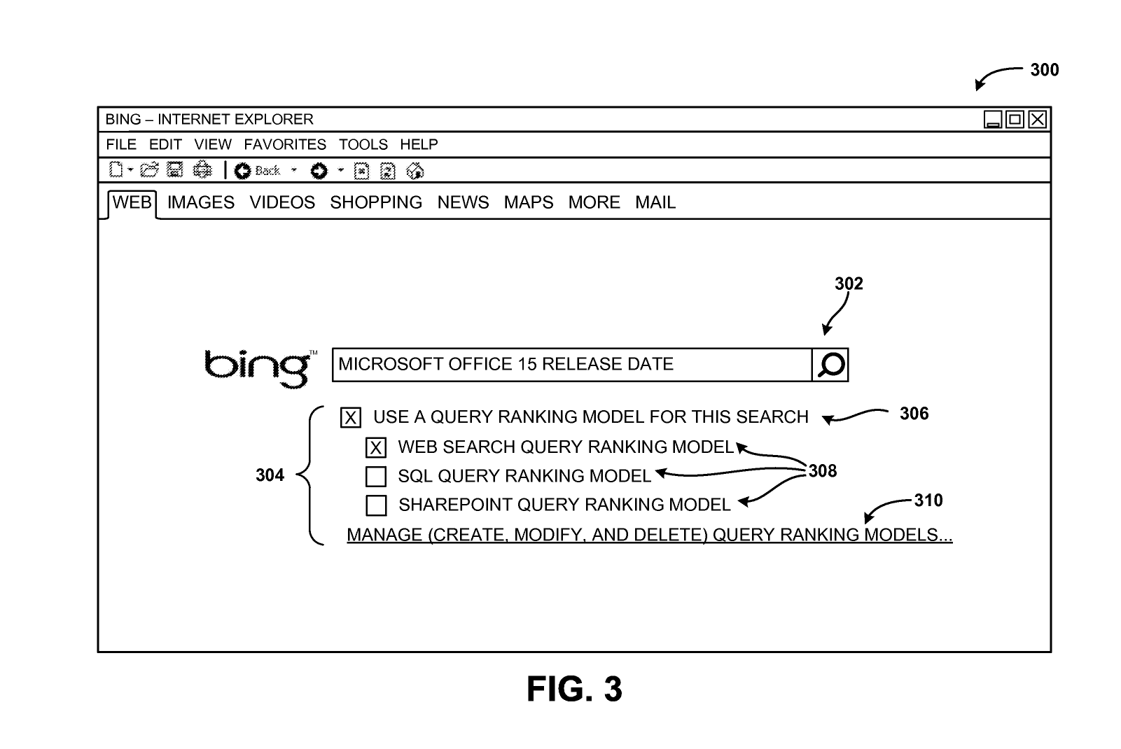

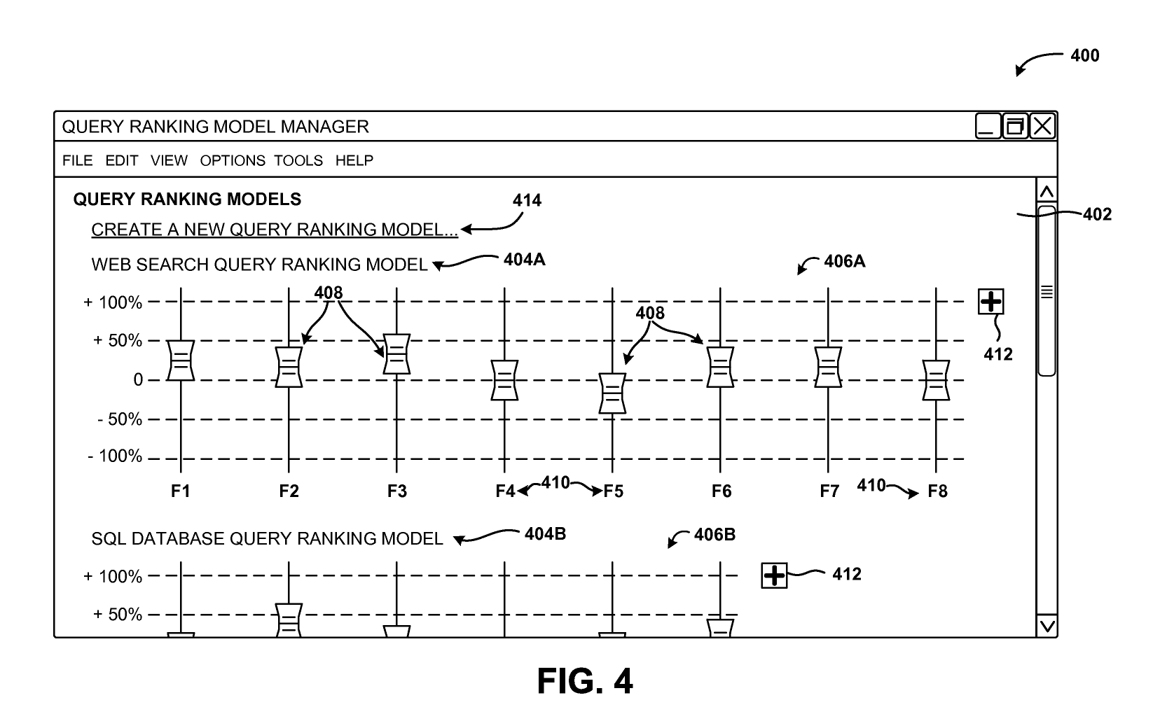

Similarly, users or other entities can create new query ranking models 114 via one or more user interfaces (“UIs”). Features can be added to and/or removed from query ranking models 114, relative weights can be adjusted, and/or modified and/or new query ranking models 114 can be saved and/or used for searches. Various aspects of illustrative UIs for interacting with the query application 108 are illustrated and described in more detail below, particularly with reference to FIGS. 3-4.

FIG. 1 illustrates one computing device 102, one network 104, one search engine 112, and one data store 118. It should be understood, however, that some implementations of the operating environment 100 include multiple computing devices 102, multiple networks 104, zero or multiple search engines 114, zero or multiple data stores 118, and/or additional or alternative hardware elements. Thus, the illustrated embodiments should be understood as being illustrative, and should not be construed as being limiting in any way.

Turning now to FIG. 2, additional aspects of the query ranking models 114 will be described in detail, according to some illustrative embodiments. As explained above with reference to FIG. 1, the query application 108 can be configured to modify a query ranking model object 110 to generate the query ranking model 114. According to various, such as the embodiment illustrated in FIG. 2, the query ranking model 114 includes a number of features 200A-N (hereinafter collectively and/or generically referred to as “features 200”) that can added to the query ranking model 114, removed from the query ranking model 114, and/or weighted with respect to one another.

As noted above, the features 200 can correspond to various parameters, constants, variables, and/or other aspects of functions, algorithms, or the like, that are used or applied by the search engine 112 to rank or order search results 120. According to various embodiments, the query ranking models 114 can include one or more features 200, each of which can be weighted according to preferences or settings associated with a user or other entity. Thus, it should be understood that by application of the query ranking models 114 when executing a particular query 116, the contents of the search results 120 can be changed and/or reordered with respect to one another. In particular, two query ranking models 114 used in accordance with a single query 116 may produce different results and/or different orders of results.

According to various embodiments, the features 200 can include various aspects or properties of documents, records, devices, or other searched entities or items. Examples of contemplated features 200 include, but are not limited to, freshness of document or record such as a creation or modification data; an average review or relevancy of a particular document or record; an absolute or relative popularity of a particular document or record; averages and/or absolute numbers of likes or dislikes with respect to a particular document or record; determined relevance of a particular document or record to an entered or received query 116; a geographic location of a resource or source associated with a particular document or record; a network location of a particular document or record; a particular word within a particular document or record, as well as an indication of how early or late the word appears in the document or record; a history of visited pages associated with a particular document or record; combinations thereof, or the like.

As such, it can be appreciated that a particular query ranking model 114 can include various features 200 that can be weighted with respect to one another to modify orders and/or ranks of search results 120 provided by the search engine 112. Although not visible in FIG. 2, it should be understood that a particular query ranking model 114 also can include a formula defining how the features 200 associated with the query ranking model 114 are applied to documents or records identified by the search engine 112. As such, the query application 108 can be configured to modify weights of features 200, as well as formulas defining how the features are or are not applied during ranking or ordering of the search results 120. An example embodiment of a UI for modifying a query ranking model 114 is illustrated and described below with reference to FIG. 4.

Turning now to FIG. 3, a UI diagram showing various aspects of a user interface for performing a search query using a query ranking model will be described according to an illustrative embodiment. FIG. 3 shows an illustrative screen display 300 generated by a device such as the computing device 102, for example, by execution of the query application 108 described herein. It should be appreciated that the UI diagram illustrated in FIG. 3 is illustrative of one contemplated embodiment, and therefore should not be construed as being limited in any way.

The screen display 300 can include various menus and/or menu options. It can be appreciated from the embodiment illustrated in FIG. 3 that the screen display 300 can include an application window generated by a web browser or other software. As such, as mentioned above, it can be appreciated that the functionality of the query application 108 described herein can be provided by a service, web page, or other resource accessed by various applications executed by the computing device 102 in addition to, or instead of, a natively executed or web-based application. The screen display 300 can include a search query input area 302. As generally is understood, the search query input area 302 can include a text input field and a UI control for submitting the query. Because these and other elements for performing searches are generally understood, the search query input area 302 is not further described herein.

The screen display 300 also can include a query ranking model menu 304. The query ranking model menu 304 can include a UI control 306 for selecting whether or not a query ranking model 114 is to be used to rank search results 120 obtained by the computing device 102. In some embodiments, the query ranking model menu 304 can be hidden and/or expanded in response to detecting selecting and/or deselecting the UI control 306. In the illustrated embodiment, the UI control 306 has been selected, indicating that the query ranking model 114 is to be submitted with a query 116 such as a search string entered into the search query input area 302. It should be understood that this embodiment is illustrative, and should not be construed as being limiting in any way.

The query ranking model menu 304 can include one or more UI controls 308 for selecting a particular query ranking model 114. As explained above, users or other entities can create multiple query ranking models 114 for various purposes. In the illustrated embodiment, a user or other entity has selected the UI control 308 for indicating that a query ranking model 114 for web searches is to be used. It should be understood that this embodiment is illustrative, and should not be construed as being limiting in any way.

The query ranking model menu 304 also can include a UI control for managing query ranking models 114. Via selection of the UI control 310, a user or other entity can create, modify, delete, and/or otherwise manage one or more query ranking models 114. In response to detecting selection of the UI control 310, the computing device 102 and/or a remotely executed application providing the functionality described herein with respect to the query application 108 can present a query ranking model management screen. An example embodiment of a query ranking model management screen is illustrated and described below with reference to FIG. 4.

Turning now to FIG. 4, a UI diagram showing various aspects of a user interface for presenting and modifying query ranking models will be described according to an illustrative embodiment. FIG. 4 shows an illustrative screen display 400 generated by a device such as the computing device 102, for example, by execution of the query application 108 described herein. It should be appreciated that the UI diagram illustrated in FIG. 4 is illustrative of one contemplated embodiment, and therefore should not be construed as being limited in any way.

The screen display 400 can include various menus and/or menu options as mentioned above with reference to FIG. 3. Similarly, it can be appreciated from the embodiment illustrated in FIG. 4 that the screen display 400 also can be provided by an application program such as a web browser, or the like in addition to, or instead of, a natively executed or web-based query application 108. The screen display 400 can include a query ranking model management screen 402 as mentioned above. It should be understood that the query ranking model management screen 402 can be, but is not necessarily, presented in response to detecting selection of the UI control 310 illustrated and described above with reference to FIG. 3.

The query ranking model management screen 402 can include various displays and/or controls for creating, modifying, deleting, and/or otherwise managing query ranking models 114. A particular query ranking model 114 that can be managed can be indicated by an indicator 404A-B (hereinafter collectively and/or generically referred to as “indicators 404”). The indicators 404 can provide an indication of a particular query ranking model 114 that can be managed via the query ranking model management screen 402. It should be understood that the illustrated indicators 404 are illustrative, and should not be construed as being limiting in any way.

The query ranking model management screen 402 also can include one or more control decks 406A-B (hereinafter collectively and/or generically referred to as “control decks 406”). The control decks 406 can include various UI controls for modifying the query ranking models 114. In the illustrated embodiment, the control decks 406 include one or more slider controls 408 for weighting the various features 200 included in a particular query ranking model 114. The control decks 406 also can include feature labels 410 for indicating a particular feature 200 that is weighted via manipulation of a respective slider control 408. It should be understood that that the illustrated feature labels 410 are illustrative only, and that the feature labels 410 can include detailed descriptions of the particular feature 200 controlled by the respective slider control 408.

Additionally, while manual manipulation of the slider controls 408 has been described herein, it should be understood that various applications, services, or the like can be configured to modify query ranking models 114. In one particular embodiment, the query application 108 or other application programs can be configured to access social networking services, online profiles, or the like, to modify weights associated with the various features 200 of a particular query ranking model 114. Thus, for example, the query application 108 or other program can determine probable preferences associated with the various features 200 based upon external considerations such as a social networking profile, an online profile, or the like, and modify the query ranking model 114 based upon these and/or other considerations. Thus, the query application 108 can be configured to provide personalized search results based upon profiles or other information associated with a particular entity such as a searcher. Because other information can be used to modify the query ranking models 114 without user manipulation of the UIs described herein, it should be understood that these embodiments are illustrative, and should not be construed as being limiting in any way.

The control decks 406 also can include UI controls 412 for adding features 200 to the query ranking models 114. While not visible in the embodiment illustrated in FIG. 4, it should be understood that that UI controls for deleting features 200 from the query ranking models 114 also can be included, if desired. Alternatively, a user or other entity can adjust a weight associated with a particular feature 200 to “0,” thereby removing the feature 200 from consideration when applying the query ranking model 114.

As shown in FIG. 4, each feature 200 of a query ranking model 114 can be weighted positively and/or negatively. Thus, the features 200 can be weighted to shift particular search result hits up or down in rankings based upon the various features 200. In some embodiments, only positive weightings are allowed or supported, and in some other embodiments, only negative weightings are allowed. As such, it should be understood that this embodiment is illustrative, and should not be construed as being limiting in any way.

The query ranking model management screen 402 also can include a UI control 414 for adding query ranking models 114. Via selection of the UI control 414, a user or other entity can create a new query ranking model 114. Although not shown in FIG. 4, UI controls for deleting query ranking models 114 can also be presented on the screen display 400, if desired. It should be appreciated that via manipulation of the UI controls 412, the slider controls 408, and/or other functionality associated with the controls decks 406, a user or other entity can modify one or more of the query ranking models 114. According to various embodiments, changes made to the query ranking models 114 via the screen display 400 can be saved by the computing device 102, used for a particular search, and/or discarded, if desired.

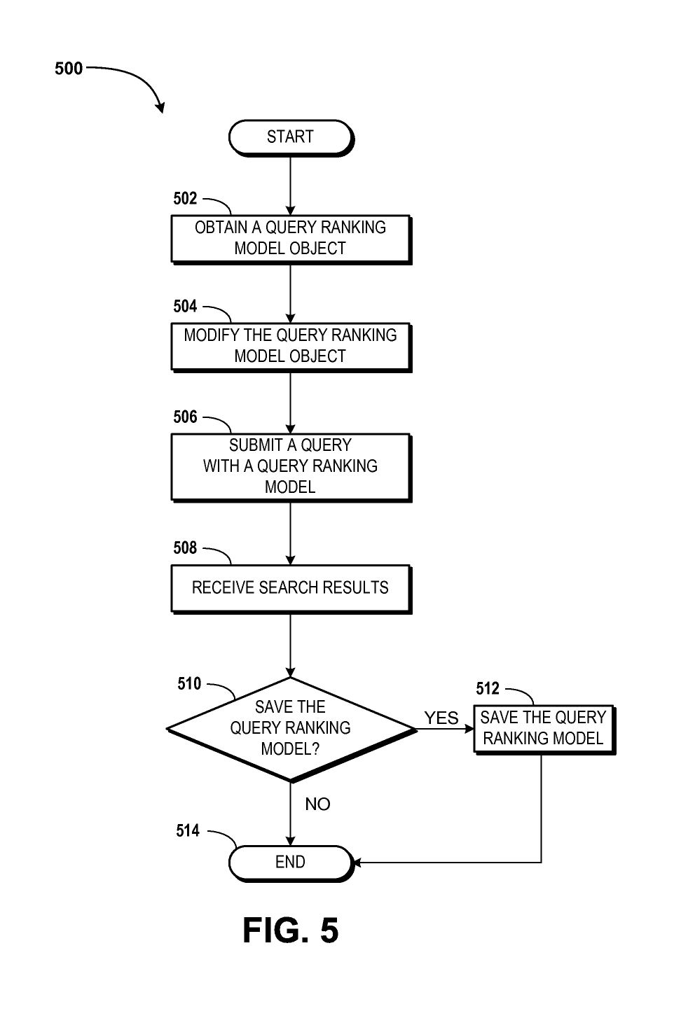

Turning now to FIG. 5, aspects of a method 500 for performing a s search using a query ranking model will be described in detail. It should be understood that the operations of the methods disclosed herein are not necessarily presented in any particular order and that performance of some or all of the operations in an alternative order(s) is possible and is contemplated. The operations have been presented in the demonstrated order for ease of description and illustration. Operations may be added, omitted, and/or performed simultaneously, without departing from the scope of the appended claims.

It also should be understood that the illustrated methods disclosed herein can be ended at any time and need not be performed in their respective entireties. Some or all operations of the methods disclosed herein, and/or substantially equivalent operations, can be performed by execution of computer-readable instructions included on a computer-storage media, as defined herein. The term “computer-readable instructions,” and variants thereof, as used in the description and claims, is used expansively herein to include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system and/or (5) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These operations, structural devices, acts, and modules may be implemented in software, in firmware, in special purpose digital logic, and any combination thereof.

For purposes of illustrating and describing the concepts of the present disclosure, the methods disclosed herein are described as being performed by the computing device 102 via execution of computer executable instructions such as, for example, the query application 108. It should be understood that these embodiments are illustrative, and should not be viewed as being limiting in any way. In particular, devices other than and/or in addition to the computing device 102 can provide the functionality described herein via execution of computer executable instructions other than and/or in addition to the query application 108.

The method 500 begins at operation 502, wherein the computing device 102 obtains a query ranking model object 110. According to various embodiments, the search engine 112 can be configured to expose the query ranking model object 110 to the computing device 102 and/or other devices accessing the search engine 112. As such, it should be understood that the computing device 102 can receive the query ranking model object 110 in response to accessing the search engine 112, in response to requesting the query ranking model object 110, and/or at other times.

From operation 502, the method 500 proceeds to operation 504, wherein the computing device 102 modifies the query ranking model object 110 to generate a query ranking model 114. As explained above, and as illustrated and described above with reference to FIG. 4, the computing device 102 can be configured to present a UI for adding, modifying, and/or deleting features 200 from a query ranking model object 110 to generate the query ranking model 114. As such, operation 504 can include presentation of the screen display 400 and/or other UIs, as well as obtaining input and/or capturing interactions with the screen display 400 and/or other UIs.

From operation 504, the method 500 proceeds to operation 506, wherein the computing device 102 submits a query such as the query 116 to the search engine 112. As illustrated and described above with reference to FIG. 1, the query 116 submitted by the computing device 102 can include the query ranking model 114. In some embodiments, the query ranking model 114 is submitted with the query 116. In some other embodiments, the query ranking model 114 is stored at the search engine 112, and the query 116 can include a flag or other data identifying the query ranking model 114 to be used in ranking search results 120 generated by the search engine 112 in response to the query 116. Thus, it should be understood that operation 506 encompasses submitting the query 116 and identifying and/or including a query ranking model 114 to be used in ranking the search results 120.

From operation 506, the method 500 proceeds to operation 508, wherein the computing device 102 receives the search results 120. As explained herein, the search results 120 received by the computing device 102 can be ranked in accordance with the query ranking model 114. Thus, the concepts and technologies disclosed herein can allow users or other entities to modify ranking models used to order and/or rank the search results 120 when submitting a query 116, and the search results 120 can be ranked in accordance with the user's or other entity's preferences.

From operation 508, the method 500 proceeds to operation 510, wherein the computing device 102 determines if the query ranking model 114 submitted with and/or identified in the query 116 in operation 506 is to be saved. The query ranking models 114 can be saved at the computing device 102 and/or elsewhere. In particular, in some embodiments the query ranking models 114 can be saved at the computing device 102 as, for example, preferences, configurations, or settings associated with the query application 108, a web browser, a profile, or the like. In some other embodiments, the query ranking model 114 can be saved as part of an online profile associated with a user. For example, the query ranking models 114 can be saved as part of a social networking profile of a social networking service, as part of a search profile associated with the search engine 112, as a user profile associated with an enterprise data delivery service, or the like. Because the query ranking models 114 can be saved at other devices and/or locations, it should be understood that these embodiments are illustrative, and should not be construed as being limiting in any way.

If the computing device 102 determines, in operation 510, that the query ranking model 114 is to be saved, the method 500 can proceed to operation 512. In operation 512, the computing device 102 can save the query ranking model 114. The saved query ranking model 114 can be associated with a particular entity such as, for example, the computing device 102, a user of the computing device 102, a social networking profile, an online profile, or the like. As such, the query ranking model 114 can be saved and associated with a particular entity for future retrieval and use, if desired. As explained above, the query ranking model 114 can be saved at one or more local and/or remote devices. From operation 512, and/or from operation 510 if the computing device 102 determines that the query ranking model 114 is not to be saved, the method 500 proceeds to operation 514. The method 500 ends at operation 514.

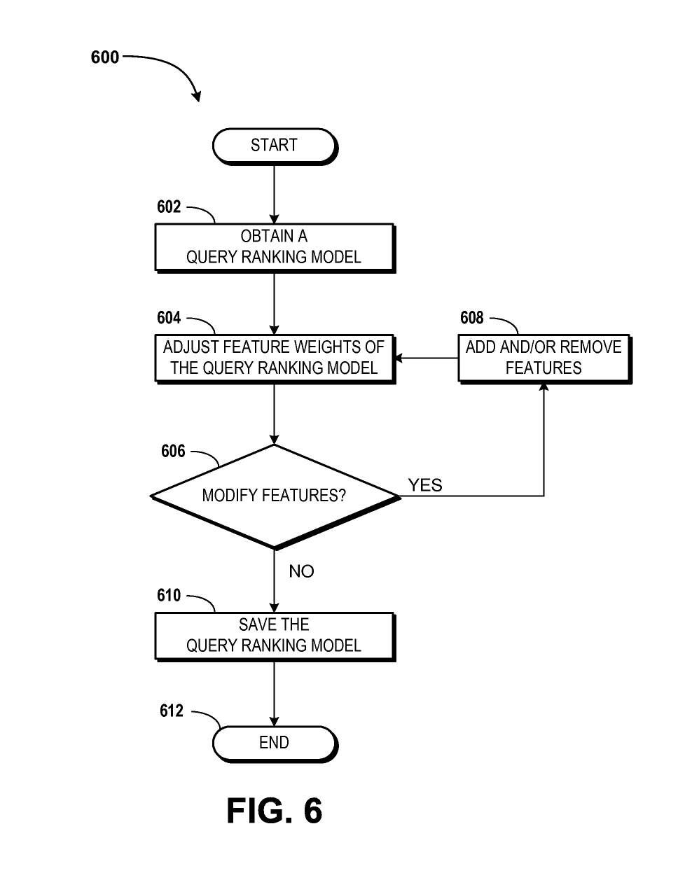

Turning now to FIG. 6, aspects of a method 600 for modifying a query ranking model will be described in detail. It should be understood that the functionality described herein with reference to FIG. 6 can, but is not necessarily, provided by the computing device 102 in response to a user accessing a query ranking model management screen such as the query ranking model management screen 402 illustrated and described above with reference to FIG. 4.

The method 600 begins at operation 602, wherein the computing device 102 obtains a query ranking model 114. In some embodiments, the query ranking model 114 can be obtained in response to detecting a selection of a particular query ranking model 114 from a list of query ranking models 114 and/or in response to selection of an option to modify a query ranking model 114 where only one query ranking model 114 is stored. In operation 602, the computing device 102 can obtain information describing the query ranking model 114 such as, for example, a definition of the query ranking model 114 such as a formula identifying one or more features 200 included in the query ranking model 114 as well as the respective weights thereof. Because obtaining the query ranking model 114 can include obtaining additional and/or alternative data, it should be understood that this embodiment is illustrative, and should not be construed as being limiting in any way.

From operation 602, the method 600 proceeds to operation 604, wherein the computing device 102 can adjust feature weights (weights of one or more features 200) of the query ranking model 114. It should be understood that the computing device 102 can be configured to present a UI for adjusting the feature weights. In some embodiments, for example, the computing device 102 can be configured to present the query ranking model management screen 402 illustrated and described above with reference to FIG. 4. In some other embodiments, the computing device 102 can obtain input from users or other entities for adjusting the feature weights of the query ranking model 114. As such, operation 604 can include detecting modification of at least one weight of at least one feature 200. Because the method 600 can be ended at any time, it should be understood that that the computing device 102 can terminate the method 600 without modifying the query ranking model 114. As such, it should be understood that this embodiment is illustrative, and should not be construed as being limiting in any way.

From operation 604, the method 600 proceeds to operation 606, wherein the computing device 102 can determine if the features 200 of the query ranking model 114 are to be modified. Thus, the computing device 102 can determine, for example, if a feature 200 is to be added to the query ranking model 114 and/or if a feature 200 of the query ranking model 114 is to be removed from the query ranking model 114. It should be understood that the determination of whether features 200 are to be added or deleted from the query ranking model 114 can be made by detecting selection of one or more UI controls for adding features 200 and/or deleting features 200 from the query ranking model 114 as illustrated and described above with reference to FIG. 4. Because the determination of operation 606 can be made in additional and/or alternative ways, it should be understood that this embodiment is illustrative, and should not be construed as being limiting in any way.

If the computing device 102 determines in operation 606 that the features 200 are to be modified, the method 600 can proceed to operation 608. In operation 608, the computing device 102 can add one or more features to the query ranking model 114, remove one or more features 200 from the query ranking model 114, and/or a combination thereof. From operation 608, the method 600 can return to operation 604, wherein the computing device 102 can again adjust feature weights of the query ranking model 114. As such, it can be appreciated that features 200 of the query ranking model 114 can be reweighted by the computing device 102 in response to adding or removing features 200 to/from the query ranking models 114. Operations 604-608 can be repeated until the computing device 102 determines, in any iteration of operation 606, that the features 200 of the query ranking model 114 are not be modified.

If the computing device 102 determines in operation 606 that the features 200 are not to be modified, the method 600 can proceed to operation 610. In operation 610, the computing device 102 can save the query ranking model 114. The query ranking model 114 can be saved in a memory, in a mass storage device, and/or at another data storage location associated with the computing device 102. Additionally, or alternatively, the query ranking model 114 can be saved at a remote storage device such as the data store 118, a data storage associated with the search engine 112, a social networking server (not illustrated), and/or at other devices or services. As explained above, the query ranking model 114 can be persisted in memory until the query 116 is submitted, if desired, after which the query ranking model 114 can be discarded. Alternatively, query ranking models 114 can be stored indefinitely. From operation 610, the method 600 proceeds to operation 612. The method 600 ends at operation 612.

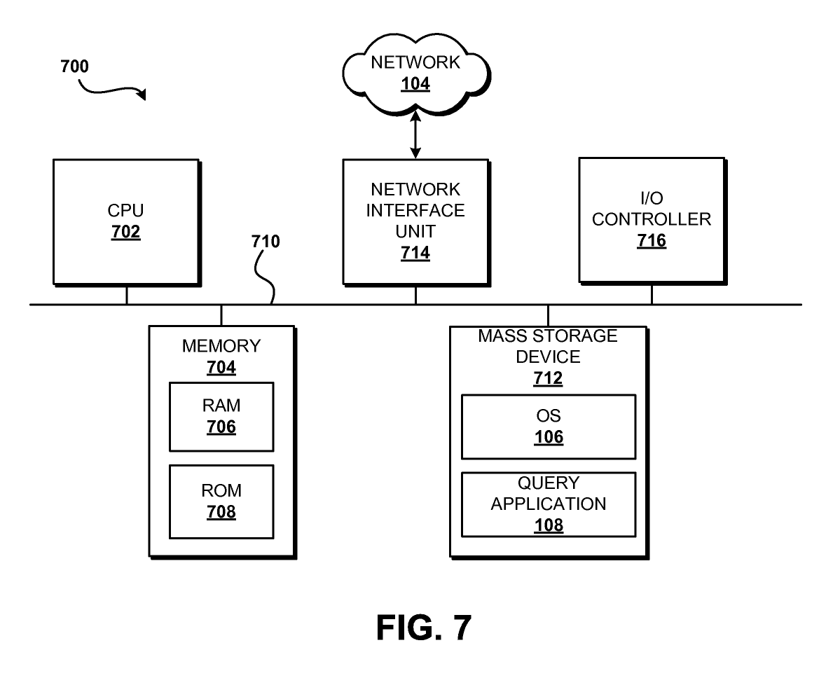

FIG. 7 illustrates an illustrative computer architecture 700 for a device capable of executing the software components described herein for query ranking models. Thus, the computer architecture 700 illustrated in FIG. 7 illustrates an architecture for a server computer, mobile phone, a PDA, a smart phone, a desktop computer, a netbook computer, a tablet computer, and/or a laptop computer. The computer architecture 700 may be utilized to execute any aspects of the software components presented herein.

The computer architecture 700 illustrated in FIG. 7 includes a central processing unit 702 (“CPU”), a system memory 704, including a random access memory 706 (“RAM”) and a read-only memory (“ROM”) 708, and a system bus 710 that couples the memory 704 to the CPU 702. A basic input/output system containing the basic routines that help to transfer information between elements within the computer architecture 700, such as during startup, is stored in the ROM 708. The computer architecture 700 further includes a mass storage device 712 for storing the operating system 106 and one or more application programs including, but not limited to, the query application 108. Although not shown in FIG. 7, the mass storage device 712 also can be configured to store the query ranking model object 110, one or more query ranking models 114, search results 120, and/or other data, if desired.

The mass storage device 712 is connected to the CPU 702 through a mass storage controller (not shown) connected to the bus 710. The mass storage device 712 and its associated computer-readable media provide non-volatile storage for the computer architecture 700. Although the description of computer-readable media contained herein refers to a mass storage device, such as a hard disk or CD-ROM drive, it should be appreciated by those skilled in the art that computer-readable media can be any available computer storage media or communication media that can be accessed by the computer architecture 700.

Communication media includes computer readable instructions, data structures, program modules, or other data in a modulated data signal such as a carrier wave or other transport mechanism and includes any delivery media. The term “modulated data signal” means a signal that has one or more of its characteristics changed or set in a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

By way of example, and not limitation, computer storage media may include volatile and non-volatile, removable and non-removable media implemented in any method or technology for storage of information such as computer-readable instructions, data structures, program modules or other data. For example, computer media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium which can be used to store the desired information and which can be accessed by the computer architecture 700. For purposes the claims, the phrase “computer storage medium” and variations thereof, does not include waves, signals, and/or other transitory and/or intangible communication media, per se.

According to various embodiments, the computer architecture 700 may operate in a networked environment using logical connections to remote computers through a network such as the network 104. The computer architecture 700 may connect to the network 104 through a network interface unit 714 connected to the bus 710. It should be appreciated that the network interface unit 714 also may be utilized to connect to other types of networks and remote computer systems, for example, the search engine 212, a social networking server (not illustrated), the data store 118, or the like. The computer architecture 700 also may include an input/output controller 716 for receiving and processing input from a number of other devices, including a keyboard, mouse, or electronic stylus (not shown in FIG. 7). Similarly, the input/output controller 716 may provide output to a display screen, a printer, or other type of output device (also not shown in FIG. 7).

It should be appreciated that the software components described herein may, when loaded into the CPU 702 and executed, transform the CPU 702 and the overall computer architecture 700 from a general-purpose computing system into a special-purpose computing system customized to facilitate the functionality presented herein. The CPU 702 may be constructed from any number of transistors or other discrete circuit elements, which may individually or collectively assume any number of states. More specifically, the CPU 702 may operate as a finite-state machine, in response to executable instructions contained within the software modules disclosed herein. These computer-executable instructions may transform the CPU 702 by specifying how the CPU 702 transitions between states, thereby transforming the transistors or other discrete hardware elements constituting the CPU 702.

Encoding the software modules presented herein also may transform the physical structure of the computer-readable media presented herein. The specific transformation of physical structure may depend on various factors, in different implementations of this description. Examples of such factors may include, but are not limited to, the technology used to implement the computer-readable media, whether the computer-readable media is characterized as primary or secondary storage, and the like. For example, if the computer-readable media is implemented as semiconductor-based memory, the software disclosed herein may be encoded on the computer-readable media by transforming the physical state of the semiconductor memory. For example, the software may transform the state of transistors, capacitors, or other discrete circuit elements constituting the semiconductor memory. The software also may transform the physical state of such components in order to store data thereupon.

As another example, the computer-readable media disclosed herein may be implemented using magnetic or optical technology. In such implementations, the software presented herein may transform the physical state of magnetic or optical media, when the software is encoded therein. These transformations may include altering the magnetic characteristics of particular locations within given magnetic media. These transformations also may include altering the physical features or characteristics of particular locations within given optical media, to change the optical characteristics of those locations. Other transformations of physical media are possible without departing from the scope and spirit of the present description, with the foregoing examples provided only to facilitate this discussion.

In light of the above, it should be appreciated that many types of physical transformations take place in the computer architecture 700 in order to store and execute the software components presented herein. It also should be appreciated that the computer architecture 700 may include other types of computing devices, including hand-held computers, embedded computer systems, personal digital assistants, and other types of computing devices known to those skilled in the art. It is also contemplated that the computer architecture 700 may not include all of the components shown in FIG. 7, may include other components that are not explicitly shown in FIG. 7, or may utilize an architecture completely different than that shown in FIG. 7.

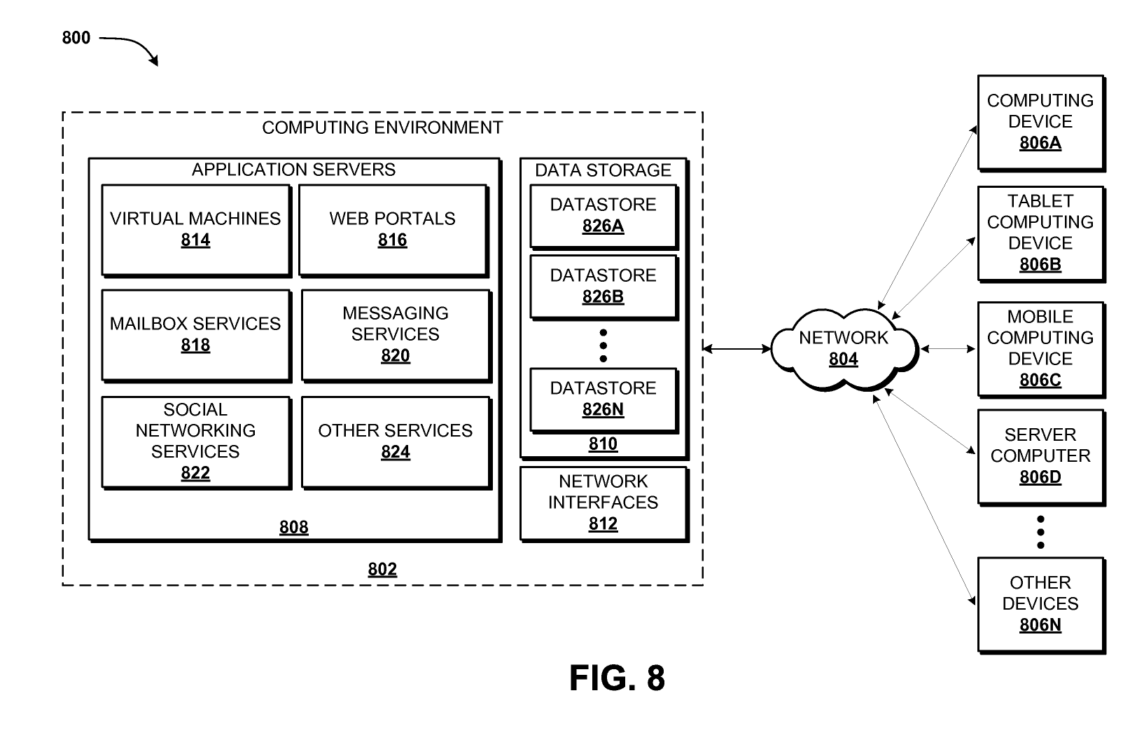

FIG. 8 illustrates an illustrative distributed computing environment 800 capable of executing the software components described herein for query ranking models. Thus, the distributed computing environment 800 illustrated in FIG. 8 can be used to provide the functionality described herein with respect to the computing device 102 and/or the search engine 112. The distributed computing environment 800 thus may be utilized to execute any aspects of the software components presented herein.

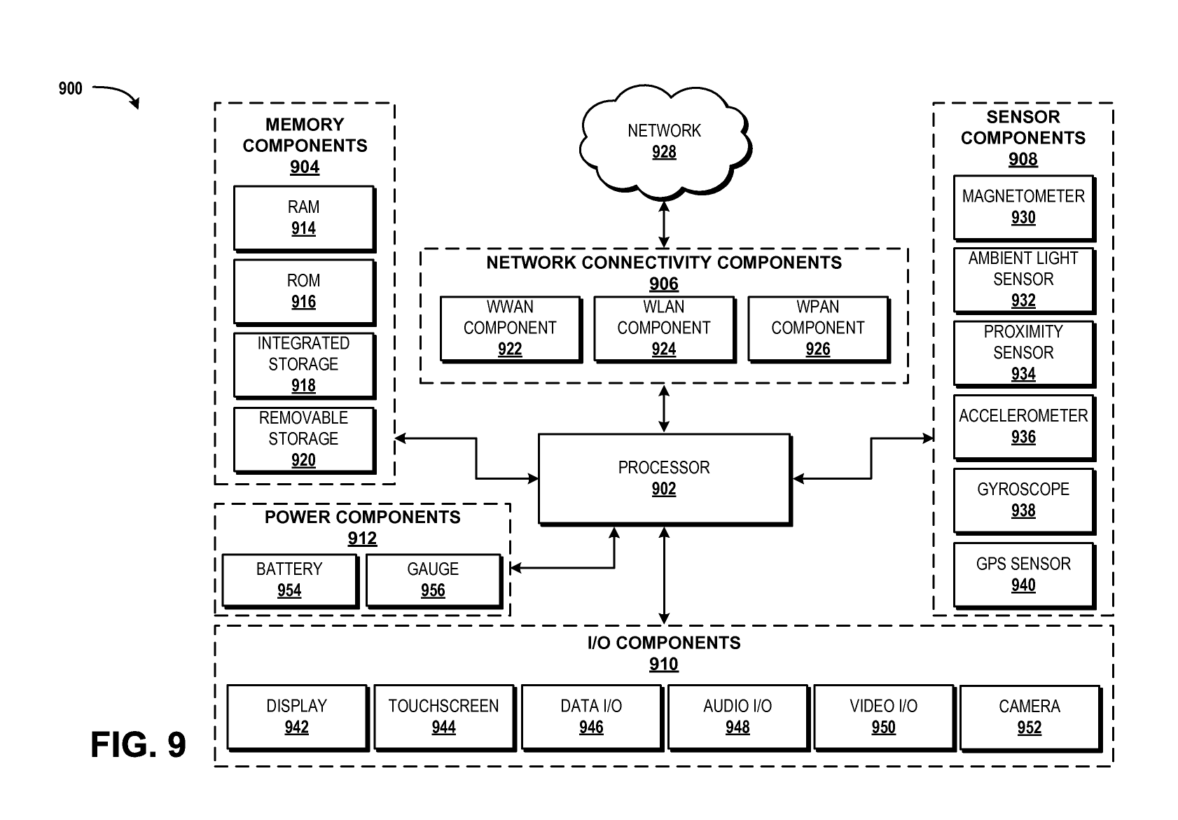

According to various implementations, the distributed computing environment 800 includes a computing environment 802 operating on, in communication with, or as part of the network 804. The network 804 also can include various access networks. According to various implementations, the functionality of the network 804 can be provided by the network 104 illustrated in FIG. 1. One or more client devices 806A-806N (hereinafter referred to collectively and/or generically as “clients 806”) can communicate with the computing environment 802 via the network 804 and/or other connections (not illustrated in FIG. 8). In the illustrated embodiment, the clients 806 include a computing device 806A such as a laptop computer, a desktop computer, or other computing device; a slate or tablet computing device (“tablet computing device”) 806B; a mobile computing device 806C such as a mobile telephone, a smart phone, or other mobile computing device; a server computer 806D; and/or other devices 806N. It should be understood that any number of clients 806 can communicate with the computing environment 802. Two example computing architectures for the clients 806 are illustrated and described herein with reference to FIGS. 7 and 9. It should be understood that the illustrated clients 806 and computing architectures illustrated and described herein are illustrative, and should not be construed as being limited in any way.

In the illustrated embodiment, the computing environment 802 includes application servers 808, data storage 810, and one or more network interfaces 812. According to various implementations, the functionality of the application servers 808 can be provided by one or more server computers that are executing as part of, or in communication with, the network 804. The application servers 808 can host various services, virtual machines, portals, and/or other resources. In the illustrated embodiment, the application servers 808 host one or more virtual machines 814 for hosting applications or other functionality. According to various implementations, the virtual machines 814 host one or more applications and/or software modules for providing the functionality described herein for query ranking models. It should be understood that this embodiment is illustrative, and should not be construed as being limiting in any way. The application servers 808 also host or provide access to one or more Web portals, link pages, Web sites, and/or other information (“Web portals”) 816.

According to various implementations, the application servers 808 also include one or more mailbox services 818 and one or more messaging services 820. The mailbox services 818 can include electronic mail (“email”) services. The mailbox services 818 also can include various personal information management (“PIM”) services including, but not limited to, calendar services, contact management services, collaboration services, and/or other services. The messaging services 820 can include, but are not limited to, instant messaging services, chat services, forum services, and/or other communication services.

The application servers 808 also can include one or more social networking services 822. The social networking services 822 can include various social networking services including, but not limited to, services for sharing or posting status updates, instant messages, links, photos, videos, and/or other information; services for commenting or displaying interest in articles, products, blogs, or other resources; and/or other services. In some embodiments, the social networking services 822 are provided by or include the FACEBOOK social networking service, the LINKEDIN professional networking service, the MYSPACE social networking service, the FOURSQUARE geographic networking service, the YAMMER office colleague networking service, and the like. In other embodiments, the social networking services 822 are provided by other services, sites, and/or providers that may or may not explicitly be known as social networking providers. For example, some web sites allow users to interact with one another via email, chat services, and/or other means during various activities and/or contexts such as reading published articles, commenting on goods or services, publishing, collaboration, gaming, and the like. Examples of such services include, but are not limited to, the WINDOWS LIVE service and the XBOX LIVE service from Microsoft Corporation in Redmond, Wash. Other services are possible and are contemplated.

The social networking services 822 also can include commenting, blogging, and/or microblogging services. Examples of such services include, but are not limited to, the YELP commenting service, the KUDZU review service, the OFFICETALK enterprise microblogging service, the TWITTER messaging service, the GOOGLE BUZZ service, and/or other services. It should be appreciated that the above lists of services are not exhaustive and that numerous additional and/or alternative social networking services 822 are not mentioned herein for the sake of brevity. As such, the above embodiments are illustrative, and should not be construed as being limited in any way.

As shown in FIG. 8, the application servers 808 also can host other services, applications, portals, and/or other resources (“other resources”) 824. The other resources 824 can include, but are not limited to, the search engine 112 and/or the query application 108 described herein. It thus can be appreciated that the computing environment 802 can provide integration of the concepts and technologies disclosed herein provided herein for query ranking models 114 with various mailbox, messaging, social networking, and/or other services or resources. For example, the concepts and technologies disclosed herein can be used to store the query ranking models 114 at social networking services, to share the query ranking models 114 with mail or message recipients, save the query ranking models 114 at search services, or the like. It should be understood that these embodiments are illustrative, and should not be construed as being limiting in any way.

As mentioned above, the computing environment 802 can include the data storage 810. According to various implementations, the functionality of the data storage 810 is provided by one or more databases operating on, or in communication with, the network 804. The functionality of the data storage 810 also can be provided by one or more server computers configured to host data for the computing environment 802. The data storage 810 can include, host, or provide one or more real or virtual datastores 826A-826N (hereinafter referred to collectively and/or generically as “datastores 826”). The datastores 826 are configured to host data used or created by the application servers 808 and/or other data. Although not illustrated in FIG. 8, the datastores 826 also can host or store the query ranking model object 110, query ranking models 114, search results 120, and/or other data, if desired.

The computing environment 802 can communicate with, or be accessed by, the network interfaces 812. The network interfaces 812 can include various types of network hardware and software for supporting communications between two or more computing devices including, but not limited to, the clients 806 and the application servers 808. It should be appreciated that the network interfaces 812 also may be utilized to connect to other types of networks and/or computer systems.

It should be understood that the distributed computing environment 800 described herein can provide any aspects of the software elements described herein with any number of virtual computing resources and/or other distributed computing functionality that can be configured to execute any aspects of the software components disclosed herein. According to various implementations of the concepts and technologies disclosed herein, the distributed computing environment 800 provides the software functionality described herein as a service to the clients 806. It should be understood that the clients 806 can include real or virtual machines including, but not limited to, server computers, web servers, personal computers, mobile computing devices, smart phones, and/or other devices. As such, various embodiments of the concepts and technologies disclosed herein enable any device configured to access the distributed computing environment 800 to utilize the functionality described herein for query ranking models.

Turning now to FIG. 9, an illustrative computing device architecture 900 for a computing device that is capable of executing various software components described herein for query ranking models. The computing device architecture 900 is applicable to computing devices that facilitate mobile computing due, in part, to form factor, wireless connectivity, and/or battery-powered operation. In some embodiments, the computing devices include, but are not limited to, mobile telephones, tablet devices, slate devices, portable video game devices, and the like. Moreover, the computing device architecture 900 is applicable to any of the clients 906 shown in FIG. 8. Furthermore, aspects of the computing device architecture 900 may be applicable to traditional desktop computers, portable computers (e.g., laptops, notebooks, ultra-portables, and netbooks), server computers, and other computer systems, such as described herein with reference to FIG. 7. For example, the single touch and multi-touch aspects disclosed herein below may be applied to desktop computers that utilize a touchscreen or some other touch-enabled device, such as a touch-enabled track pad or touch-enabled mouse.

The computing device architecture 900 illustrated in FIG. 9 includes a processor 902, memory components 904, network connectivity components 906, sensor components 908, input/output components 910, and power components 912. In the illustrated embodiment, the processor 902 is in communication with the memory components 904, the network connectivity components 906, the sensor components 908, the input/output (“I/O”) components 910, and the power components 912. Although no connections are shown between the individuals components illustrated in FIG. 9, the components can interact to carry out device functions. In some embodiments, the components are arranged so as to communicate via one or more busses (not shown).

The processor 902 includes a central processing unit (“CPU”) configured to process data, execute computer-executable instructions of one or more application programs, and communicate with other components of the computing device architecture 900 in order to perform various functionality described herein. The processor 902 may be utilized to execute aspects of the software components presented herein and, particularly, those that utilize, at least in part, a touch-enabled input.

In some embodiments, the processor 902 includes a graphics processing unit (“GPU”) configured to accelerate operations performed by the CPU, including, but not limited to, operations performed by executing general-purpose scientific and engineering computing applications, as well as graphics-intensive computing applications such as high resolution video (e.g., 720p, 1080p, and greater), video games, three-dimensional (“3D”) modeling applications, and the like. In some embodiments, the processor 902 is configured to communicate with a discrete GPU (not shown). In any case, the CPU and GPU may be configured in accordance with a co-processing CPU/GPU computing model, wherein the sequential part of an application executes on the CPU and the computationally-intensive part is accelerated by the GPU.

In some embodiments, the processor 902 is, or is included in, a system-on-chip (“SoC”) along with one or more of the other components described herein below. For example, the SoC may include the processor 902, a GPU, one or more of the network connectivity components 906, and one or more of the sensor components 908. In some embodiments, the processor 902 is fabricated, in part, utilizing a package-on-package (“PoP”) integrated circuit packaging technique. Moreover, the processor 902 may be a single core or multi-core processor.

The processor 902 may be created in accordance with an ARM architecture, available for license from ARM HOLDINGS of Cambridge, United Kingdom. Alternatively, the processor 902 may be created in accordance with an x86 architecture, such as is available from INTEL CORPORATION of Mountain View, Calif. and others. In some embodiments, the processor 902 is a SNAPDRAGON SoC, available from QUALCOMM of San Diego, Calif., a TEGRA SoC, available from NVIDIA of Santa Clara, Calif., a HUMMINGBIRD SoC, available from SAMSUNG of Seoul, South Korea, an Open Multimedia Application Platform (“OMAP”) SoC, available from TEXAS INSTRUMENTS of Dallas, Tex., a customized version of any of the above SoCs, or a proprietary SoC.

The memory components 904 include a random access memory (“RAM”) 914, a read-only memory (“ROM”) 916, an integrated storage memory (“integrated storage”) 918, and a removable storage memory (“removable storage”) 920. In some embodiments, the RAM 914 or a portion thereof, the ROM 916 or a portion thereof, and/or some combination the RAM 914 and the ROM 916 is integrated in the processor 902. In some embodiments, the ROM 916 is configured to store a firmware, an operating system or a portion thereof (e.g., operating system kernel), and/or a bootloader to load an operating system kernel from the integrated storage 918 or the removable storage 920.

The integrated storage 918 can include a solid-state memory, a hard disk, or a combination of solid-state memory and a hard disk. The integrated storage 918 may be soldered or otherwise connected to a logic board upon which the processor 902 and other components described herein also may be connected. As such, the integrated storage 918 is integrated in the computing device. The integrated storage 918 is configured to store an operating system or portions thereof, application programs, data, and other software components described herein.

The removable storage 920 can include a solid-state memory, a hard disk, or a combination of solid-state memory and a hard disk. In some embodiments, the removable storage 920 is provided in lieu of the integrated storage 918. In other embodiments, the removable storage 920 is provided as additional optional storage. In some embodiments, the removable storage 920 is logically combined with the integrated storage 918 such that the total available storage is made available and shown to a user as a total combined capacity of the integrated storage 918 and the removable storage 920.

The removable storage 920 is configured to be inserted into a removable storage memory slot (not shown) or other mechanism by which the removable storage 920 is inserted and secured to facilitate a connection over which the removable storage 920 can communicate with other components of the computing device, such as the processor 902. The removable storage 920 may be embodied in various memory card formats including, but not limited to, PC card, CompactFlash card, memory stick, secure digital (“SD”), miniSD, microSD, universal integrated circuit card (“UICC”) (e.g., a subscriber identity module (“SIM”) or universal SIM (“USIM”)), a proprietary format, or the like.

It can be understood that one or more of the memory components 904 can store an operating system. According to various embodiments, the operating system includes, but is not limited to, SYMBIAN OS from SYMBIAN LIMITED, WINDOWS MOBILE OS from Microsoft Corporation of Redmond, Wash., WINDOWS PHONE OS from Microsoft Corporation, WINDOWS from Microsoft Corporation, PALM WEBOS from Hewlett-Packard Company of Palo Alto, Calif., BLACKBERRY OS from Research In Motion Limited of Waterloo, Ontario, Canada, IOS from Apple Inc. of Cupertino, Calif., and ANDROID OS from Google Inc. of Mountain View, Calif. Other operating systems are contemplated.

The network connectivity components 906 include a wireless wide area network component (“WWAN component”) 922, a wireless local area network component (“WLAN component”) 924, and a wireless personal area network component (“WPAN component”) 926. The network connectivity components 906 facilitate communications to and from a network 928, which may be a WWAN, a WLAN, or a WPAN. Although a single network 928 is illustrated, the network connectivity components 906 may facilitate simultaneous communication with multiple networks. For example, the network connectivity components 906 may facilitate simultaneous communications with multiple networks via one or more of a WWAN, a WLAN, or a WPAN.

In some embodiments, the network 928 can be provided by one or more of the networks 104, 804. In some embodiments, the network 928 can include one or more of the networks 104, 804. In other embodiments, the network 928 can provide access to one or more of the networks 104, 804.

The network 928 may be a WWAN, such as a mobile telecommunications network utilizing one or more mobile telecommunications technologies to provide voice and/or data services to a computing device utilizing the computing device architecture 900 via the WWAN component 922. The mobile telecommunications technologies can include, but are not limited to, Global System for Mobile communications (“GSM”), Code Division Multiple Access (“CDMA”) ONE, CDMA2000, Universal Mobile Telecommunications System (“UMTS”), Long Term Evolution (“LTE”), and Worldwide Interoperability for Microwave Access (“WiMAX”). Moreover, the network 928 may utilize various channel access methods (which may or may not be used by the aforementioned standards) including, but not limited to, Time Division Multiple Access (“TDMA”), Frequency Division Multiple Access (“FDMA”), CDMA, wideband CDMA (“W-CDMA”), Orthogonal Frequency Division Multiplexing (“OFDM”), Space Division Multiple Access (“SDMA”), and the like. Data communications may be provided using General Packet Radio Service (“GPRS”), Enhanced Data rates for Global Evolution (“EDGE”), the High-Speed Packet Access (“HSPA”) protocol family including High-Speed Downlink Packet Access (“HSDPA”), Enhanced Uplink (“EUL”) or otherwise termed High-Speed Uplink Packet Access (“HSUPA”), Evolved HSPA (“HSPA+”), LTE, and various other current and future wireless data access standards. The network 928 may be configured to provide voice and/or data communications with any combination of the above technologies. The network 928 may be configured to or adapted to provide voice and/or data communications in accordance with future generation technologies.

In some embodiments, the WWAN component 922 is configured to provide dual-multi-mode connectivity to the network 928. For example, the WWAN component 922 may be configured to provide connectivity to the network 928, wherein the network 928 provides service via GSM and UMTS technologies, or via some other combination of technologies. Alternatively, multiple WWAN components 922 may be utilized to perform such functionality, and/or provide additional functionality to support other non-compatible technologies (i.e., incapable of being supported by a single WWAN component). The WWAN component 922 may facilitate similar connectivity to multiple networks (e.g., a UMTS network and an LTE network).

The network 928 may be a WLAN operating in accordance with one or more Institute of Electrical and Electronic Engineers (“IEEE”) 802.11 standards, such as IEEE 802.11a, 802.11b, 802.11g, 802.11n, and/or future 802.11 standard (referred to herein collectively as WI-FI). Draft 802.11 standards are also contemplated. In some embodiments, the WLAN is implemented utilizing one or more wireless WI-FI access points. In some embodiments, one or more of the wireless WI-FI access points are another computing device with connectivity to a WWAN that are functioning as a WI-FI hotspot. The WLAN component 924 is configured to connect to the network 928 via the WI-FI access points. Such connections may be secured via various encryption technologies including, but not limited, WI-FI Protected Access (“WPA”), WPA2, Wired Equivalent Privacy (“WEP”), and the like.

The network 928 may be a WPAN operating in accordance with Infrared Data Association (“IrDA”), BLUETOOTH, wireless Universal Serial Bus (“USB”), Z-Wave, ZIGBEE, or some other short-range wireless technology. In some embodiments, the WPAN component 926 is configured to facilitate communications with other devices, such as peripherals, computers, or other computing devices via the WPAN.

The sensor components 908 include a magnetometer 930, an ambient light sensor 932, a proximity sensor 934, an accelerometer 936, a gyroscope 938, and a Global Positioning System sensor (“GPS sensor”) 940. It is contemplated that other sensors, such as, but not limited to, temperature sensors or shock detection sensors, also may be incorporated in the computing device architecture 900.

The magnetometer 930 is configured to measure the strength and direction of a magnetic field. In some embodiments the magnetometer 930 provides measurements to a compass application program stored within one of the memory components 904 in order to provide a user with accurate directions in a frame of reference including the cardinal directions, north, south, east, and west. Similar measurements may be provided to a navigation application program that includes a compass component. Other uses of measurements obtained by the magnetometer 930 are contemplated.

The ambient light sensor 932 is configured to measure ambient light. In some embodiments, the ambient light sensor 932 provides measurements to an application program stored within one the memory components 904 in order to automatically adjust the brightness of a display (described below) to compensate for low-light and high-light environments. Other uses of measurements obtained by the ambient light sensor 932 are contemplated.

The proximity sensor 934 is configured to detect the presence of an object or thing in proximity to the computing device without direct contact. In some embodiments, the proximity sensor 934 detects the presence of a user's body (e.g., the user's face) and provides this information to an application program stored within one of the memory components 904 that utilizes the proximity information to enable or disable some functionality of the computing device. For example, a telephone application program may automatically disable a touchscreen (described below) in response to receiving the proximity information so that the user's face does not inadvertently end a call or enable/disable other functionality within the telephone application program during the call. Other uses of proximity as detected by the proximity sensor 934 are contemplated.

The accelerometer 936 is configured to measure proper acceleration. In some embodiments, output from the accelerometer 936 is used by an application program as an input mechanism to control some functionality of the application program. For example, the application program may be a video game in which a character, a portion thereof, or an object is moved or otherwise manipulated in response to input received via the accelerometer 936. In some embodiments, output from the accelerometer 936 is provided to an application program for use in switching between landscape and portrait modes, calculating coordinate acceleration, or detecting a fall. Other uses of the accelerometer 936 are contemplated.

The gyroscope 938 is configured to measure and maintain orientation. In some embodiments, output from the gyroscope 938 is used by an application program as an input mechanism to control some functionality of the application program. For example, the gyroscope 938 can be used for accurate recognition of movement within a 3D environment of a video game application or some other application. In some embodiments, an application program utilizes output from the gyroscope 938 and the accelerometer 936 to enhance control of some functionality of the application program. Other uses of the gyroscope 938 are contemplated.

The GPS sensor 940 is configured to receive signals from GPS satellites for use in calculating a location. The location calculated by the GPS sensor 940 may be used by any application program that requires or benefits from location information. For example, the location calculated by the GPS sensor 940 may be used with a navigation application program to provide directions from the location to a destination or directions from the destination to the location. Moreover, the GPS sensor 940 may be used to provide location information to an external location-based service, such as E911 service. The GPS sensor 940 may obtain location information generated via WI-FI, WIMAX, and/or cellular triangulation techniques utilizing one or more of the network connectivity components 906 to aid the GPS sensor 940 in obtaining a location fix. The GPS sensor 940 may also be used in Assisted GPS (“A-GPS”) systems.

The I/O components 910 include a display 942, a touchscreen 944, a data I/O interface component (“data I/O”) 946, an audio I/O interface component (“audio I/O”) 948, a video I/O interface component (“video I/O”) 950, and a camera 952. In some embodiments, the display 942 and the touchscreen 944 are combined. In some embodiments two or more of the data I/O component 946, the audio I/O component 948, and the video I/O component 950 are combined. The I/O components 910 may include discrete processors configured to support the various interface described below, or may include processing functionality built-in to the processor 902.

The display 942 is an output device configured to present information in a visual form. In particular, the display 942 may present graphical user interface (“GUI”) elements, text, images, video, notifications, virtual buttons, virtual keyboards, messaging data, Internet content, device status, time, date, calendar data, preferences, map information, location information, and any other information that is capable of being presented in a visual form. In some embodiments, the display 942 is a liquid crystal display (“LCD”) utilizing any active or passive matrix technology and any backlighting technology (if used). In some embodiments, the display 942 is an organic light emitting diode (“OLED”) display. Other display types are contemplated.

The touchscreen 944 is an input device configured to detect the presence and location of a touch. The touchscreen 944 may be a resistive touchscreen, a capacitive touchscreen, a surface acoustic wave touchscreen, an infrared touchscreen, an optical imaging touchscreen, a dispersive signal touchscreen, an acoustic pulse recognition touchscreen, or may utilize any other touchscreen technology. In some embodiments, the touchscreen 944 is incorporated on top of the display 942 as a transparent layer to enable a user to use one or more touches to interact with objects or other information presented on the display 942. In other embodiments, the touchscreen 944 is a touch pad incorporated on a surface of the computing device that does not include the display 942. For example, the computing device may have a touchscreen incorporated on top of the display 942 and a touch pad on a surface opposite the display 942.

In some embodiments, the touchscreen 944 is a single-touch touchscreen. In other embodiments, the touchscreen 944 is a multi-touch touchscreen. In some embodiments, the touchscreen 944 is configured to detect discrete touches, single touch gestures, and/or multi-touch gestures. These are collectively referred to herein as gestures for convenience. Several gestures will now be described. It should be understood that these gestures are illustrative and are not intended to limit the scope of the appended claims. Moreover, the described gestures, additional gestures, and/or alternative gestures may be implemented in software for use with the touchscreen 944. As such, a developer may create gestures that are specific to a particular application program.

In some embodiments, the touchscreen 944 supports a tap gesture in which a user taps the touchscreen 944 once on an item presented on the display 942. The tap gesture may be used for various reasons including, but not limited to, opening or launching whatever the user taps. In some embodiments, the touchscreen 944 supports a double tap gesture in which a user taps the touchscreen 944 twice on an item presented on the display 942. The double tap gesture may be used for various reasons including, but not limited to, zooming in or zooming out in stages. In some embodiments, the touchscreen 944 supports a tap and hold gesture in which a user taps the touchscreen 944 and maintains contact for at least a pre-defined time. The tap and hold gesture may be used for various reasons including, but not limited to, opening a context-specific menu.

In some embodiments, the touchscreen 944 supports a pan gesture in which a user places a finger on the touchscreen 944 and maintains contact with the touchscreen 944 while moving the finger on the touchscreen 944. The pan gesture may be used for various reasons including, but not limited to, moving through screens, images, or menus at a controlled rate. Multiple finger pan gestures are also contemplated. In some embodiments, the touchscreen 944 supports a flick gesture in which a user swipes a finger in the direction the user wants the screen to move. The flick gesture may be used for various reasons including, but not limited to, scrolling horizontally or vertically through menus or pages. In some embodiments, the touchscreen 944 supports a pinch and stretch gesture in which a user makes a pinching motion with two fingers (e.g., thumb and forefinger) on the touchscreen 944 or moves the two fingers apart. The pinch and stretch gesture may be used for various reasons including, but not limited to, zooming gradually in or out of a website, map, or picture.

Although the above gestures have been described with reference to the use one or more fingers for performing the gestures, other appendages such as toes or objects such as styluses may be used to interact with the touchscreen 944. As such, the above gestures should be understood as being illustrative and should not be construed as being limiting in any way.

The data I/O interface component 946 is configured to facilitate input of data to the computing device and output of data from the computing device. In some embodiments, the data I/O interface component 946 includes a connector configured to provide wired connectivity between the computing device and a computer system, for example, for synchronization operation purposes. The connector may be a proprietary connector or a standardized connector such as USB, micro-USB, mini-USB, or the like. In some embodiments, the connector is a dock connector for docking the computing device with another device such as a docking station, audio device (e.g., a digital music player), or video device.

The audio I/O interface component 948 is configured to provide audio input and/or output capabilities to the computing device. In some embodiments, the audio I/O interface component 946 includes a microphone configured to collect audio signals. In some embodiments, the audio I/O interface component 946 includes a headphone jack configured to provide connectivity for headphones or other external speakers. In some embodiments, the audio interface component 948 includes a speaker for the output of audio signals. In some embodiments, the audio I/O interface component 946 includes an optical audio cable out.

The video I/O interface component 950 is configured to provide video input and/or output capabilities to the computing device. In some embodiments, the video I/O interface component 950 includes a video connector configured to receive video as input from another device (e.g., a video media player such as a DVD or BLURAY player) or send video as output to another device (e.g., a monitor, a television, or some other external display). In some embodiments, the video I/O interface component 950 includes a High-Definition Multimedia Interface (“HDMI”), mini-HDMI, micro-HDMI, DisplayPort, or proprietary connector to input/output video content. In some embodiments, the video I/O interface component 950 or portions thereof is combined with the audio I/O interface component 948 or portions thereof.

The camera 952 can be configured to capture still images and/or video. The camera 952 may utilize a charge coupled device (“CCD”) or a complementary metal oxide semiconductor (“CMOS”) image sensor to capture images. In some embodiments, the camera 952 includes a flash to aid in taking pictures in low-light environments. Settings for the camera 952 may be implemented as hardware or software buttons.

Although not illustrated, one or more hardware buttons may also be included in the computing device architecture 900. The hardware buttons may be used for controlling some operational aspect of the computing device. The hardware buttons may be dedicated buttons or multi-use buttons. The hardware buttons may be mechanical or sensor-based.

The illustrated power components 912 include one or more batteries 954, which can be connected to a battery gauge 956. The batteries 954 may be rechargeable or disposable. Rechargeable battery types include, but are not limited to, lithium polymer, lithium ion, nickel cadmium, and nickel metal hydride. Each of the batteries 954 may be made of one or more cells.

The battery gauge 956 can be configured to measure battery parameters such as current, voltage, and temperature. In some embodiments, the battery gauge 956 is configured to measure the effect of a battery's discharge rate, temperature, age and other factors to predict remaining life within a certain percentage of error. In some embodiments, the battery gauge 956 provides measurements to an application program that is configured to utilize the measurements to present useful power management data to a user. Power management data may include one or more of a percentage of battery used, a percentage of battery remaining, a battery condition, a remaining time, a remaining capacity (e.g., in watt hours), a current draw, and a voltage.

The power components 912 may also include a power connector, which may be combined with one or more of the aforementioned I/O components 910. The power components 912 may interface with an external power system or charging equipment via a power I/O component 944.

Based on the foregoing, it should be appreciated that technologies for query ranking models have been disclosed herein. Although the subject matter presented herein has been described in language specific to computer structural features, methodological and transformative acts, specific computing machinery, and computer readable media, it is to be understood that the invention defined in the appended claims is not necessarily limited to the specific features, acts, or media described herein. Rather, the specific features, acts and mediums are disclosed as example forms of implementing the claims.

The subject matter described above is provided by way of illustration only and should not be construed as limiting. Various modifications and changes may be made to the subject matter described herein without following the example embodiments and applications illustrated and described, and without departing from the true spirit and scope of the present invention, which is set forth in the following claims.

We claim:

1. A computer-implemented method for requesting a search using a query ranking model, the computer-implemented method comprising performing computer-implemented operations for:
obtaining, at a computer executing a query application, a query ranking model object defining a ranking model used by a search engine;
generating, based upon the query ranking model object, a query ranking model comprising at least one feature corresponding to an aspect to be considered during ranking of search results by the search engine;
submitting a query for execution by the search engine, the query identifying the query ranking model to be used by the search engine; and
receiving the search results from the search engine, the search results being ordered in accordance with the query ranking model.

2. The method of claim 1, wherein identifying the query ranking model comprises submitting the query ranking model as an object with the query.

3. The method of claim 1, further comprising:
saving the query ranking model at a data storage device; and
associating the query ranking model with an entity.

4. The method of claim 1, further comprising modifying the query ranking model.

5. The method of claim 4, wherein modifying the query ranking model further comprises
identifying the at least one feature,
adjusting a weight of the at least one feature, and
saving the query ranking model as modified by adjusting the weight.

6. The method of claim 4, wherein the at least one feature comprises a plurality of features, and wherein modifying the query ranking model further comprises
adjusting at least one weight associated with the plurality of features,
determining if the plurality of features are to be modified, and
saving the query ranking model as modified by adjusting the at least one weight.

7. The method of claim 6, wherein determining if the plurality of features are to be modified comprises at least one of
determining if a new feature is to be added to the query ranking model, or
determining if at least one of the plurality of features is to be removed from the query ranking model.

8. The method of claim 6, wherein adjusting the at least one weight comprises
presenting a user interface comprising at least one control for adjusting the at least one weight, and
receiving input corresponding to a change to the at least one weight.

9. The method of claim 1, wherein the query ranking model object is exposed as an object by the search engine.

10. A computer storage medium having computer readable instructions stored thereupon that, when executed by a computer, cause the computer to:
obtain a query ranking model object defining a ranking model used by a search engine, the query ranking model object being exposed as an object by the search engine;
generate, based upon the query ranking model object, a query ranking model comprising a feature considered during ranking of search results by the search engine;
submit a query to the search engine, the query comprising data identifying the query ranking model for use by the search engine when executing the query; and
receive the search results from the search engine, the search results being ordered in accordance with the query ranking model.

11. The computer storage medium of claim 10, wherein the data identifying the query ranking model comprises an object corresponding to the query ranking model.

12. The computer storage medium of claim 10, further comprising computer readable instructions that, when executed by the computer, cause the computer to save the query ranking model at a data storage device with data associating the query ranking model with an entity.

13. The computer storage medium of claim 10, wherein generating the query ranking model further comprises adjusting a weight of the feature of the query ranking model object.

14. The computer storage medium of claim 10, further comprising computer readable instructions that, when executed by the computer, cause the computer to modify the query ranking model, wherein modifying the query ranking model comprises
adjusting a weight associated with the feature,
determining a new feature is to be added to the query ranking model,
determining if the feature is to be removed from the query ranking model, and
saving the query ranking model as modified by adjusting the weight.

15. The computer storage medium of claim 14, wherein adjusting the weight comprises
presenting a user interface comprising at least one control for adjusting the weight, and
receiving input corresponding to a change to the weight.

16. The computer storage medium of claim 10, further comprising computer readable instructions that, when executed by the computer, cause the computer to receive data indicating that the query ranking model is to be used, and obtaining the query ranking model object in response to receiving the data.

17. A computer storage medium having computer readable instructions stored thereupon that, when executed by a computer, cause the computer to:
receive data indicating that a query ranking model is to be used when executing a query;
in response to receiving the data, obtain a query ranking model object defining a ranking model used by a search engine, the query ranking model object being exposed as an object by the search engine;
generate, based upon the query ranking model object, the query ranking model, the query ranking model comprising features considered during ranking of search results by the search engine;
submit the query to the search engine with data identifying the query ranking model; and
receive the search results from the search engine, the search results being ordered in accordance with the query ranking model.

18. The computer storage medium of claim 17, further comprising computer readable instructions that, when executed by the computer, cause the computer to modify the query ranking model, wherein modifying the query ranking model comprises
obtaining the query ranking model from a storage device,
adjusting a weight associated with at least one of the features,
determining if the features are to be modified, and
saving the query ranking model as modified by adjusting the weight.

19. The computer storage medium of claim 18, wherein adjusting the weight comprises
presenting a user interface comprising at least one control for adjusting the weight, and
receiving input corresponding to a change to the weight.

20. The computer storage medium of claim 19, wherein determining if the features are to be modified comprises
presenting a further user interface comprising a control for adding a feature to the query ranking model and further control for removing a feature from the query ranking model, and
detecting manipulation of at least one of the control or the further control.
